(19) United States
(12) Patent Application Publication
(10) Pub. No.: US 2018/0036908 A1
(43) Pub. Date: Feb. 8, 2018

(54) PROCESS AND APPARATUS FOR MAKING A FIBER CEMENT SHEET

(71) Applicants: Etex Services NV, Kapelle-op-den-Bos (BE); Eternit NV, Kapelle-op-den-Bos (BE)

(72) Inventors: Bertrand Van Acoleyen, Kapelle-op-den-Bos (BE); Martin Rys, Kapelle-op-den-Bos (BE)

(21) Appl. No.: 15/555,330

(22) PCT Filed: Mar. 2, 2016
(86) PCT No.: PCT/EP2016/054459

§ 371 Date: Sep. 1, 2017

(30) Foreign Application Priority Data
Mar. 9, 2015 (EP) 15158218.6

(51) Int. Cl. B28B 1/52; B28B 5/02

(52) U.S. Cl. CPC B28B 1/526; B28B 5/027

(57) ABSTRACT

The present invention relates to processes and apparatuses for producing fiber cement sheets as well as fiber cement sheets obtainable therewith. The processes according to the present invention at least comprise the steps of: (a) providing a cementitious slurry comprising fibers, (b) continuously discharging the slurry on an endless water-permeable transport belt, and (c) removing excess of water from the slurry through the water-permeable transport belt to form a fiber cement sheet with a predetermined thickness. By using a water-permeable transport belt for removing the excess of water from the fiber cement sheet, both the thickness and the density of the sheet can be accurately tuned, without resulting in a spring-back of the thickness of the sheet at the end of the production process. The present invention further relates to various uses of the fiber cement sheets obtainable by the processes of the invention in the building industry.

### FIELD OF THE INVENTION

The present invention relates to processes and apparatuses for producing fiber cement sheets as well as fiber cement sheets obtainable therewith. The present invention further relates to various uses of the fiber cement sheets, obtainable by these processes, as building materials.

### BACKGROUND OF THE INVENTION

The Hatschek process for the production of fiber cement sheets is well known in the art. Typically, a number of fiber cement monolayers are created by means of successively installed rotating sieve drums. The layers are picked up and stacked on an endless water-permeable transport belt so as to form a fiber cement multilayered slab. The multilayered slab, which is transported in the production direction, is subsequently contacted by a rotating accumulator roll, which ensures the accumulation of a plurality of fiber cement multilayered slabs. After reaching a predefined thickness, the resulting fiber cement sheet is cut, taken from the roll, and put on a transport device. The fiber cement sheet is subsequently optionally processed and cured in a suitable way to obtain the finished end product.

Inherent to the Hatschek process, however, is the fact that the resulting fiber cement sheets are characterized by a low ratio between the mechanical strength in the crosswise to the longitudinal direction. The reason is that the fibers are not randomly oriented within the sheets but are aligned predominantly in the lengthwise direction of the sheet (also called the machine or longitudinal direction). The resulting sheet is consequently not isotropic and the strength in the cross direction (i.e. the direction normal to the machine direction, also called the transversal direction) is lower than the strength in the machine direction. Higher production speeds increase the pronounced tendency of fiber orientation in the machine direction.

As an alternative to the Hatschek process, flow-on processes for the production of fiber cement sheets were developed.

However, none of these flow-on processes succeeded in producing fiber cement products having the characteristics of (i) having the fibers uniformly and homogenously dispersed in the cementitious matrix and simultaneously (ii) having the desired density and dimensions.

For instance, U.S. Pat. No. 3,974,024 and U.S. Pat. No. 4,194,946 disclose processes for continuously preparing glass fiber reinforced cement products. However, in these processes, fibers and cement slurry are deposited on the filter belt by means of separate devices and in separate process stages. Subsequently, the cement slurry and the fibers, as deposited on the belt, are treated with a so-called “beating” device in order to mix the fibers with the slurry and to obtain at least some degree of homogenous dispersion of the fibers in the cement matrix. These steps are time-consuming, laborious, expensive and not very effective.

Moreover, the known flow-on processes were shown to have the disadvantage that the final fiber cement products do not have the desired density.

In particular, in the known processes, the step of evacuating water is usually performed only by means of mechanical force, such as by means of a belt press or a pressure plate. However, since a belt press or pressure plate typically causes the entire slurry to be pressed aside, only the thickness of the sheet is reduced, without however increasing the density. Such processes therefore do not allow to accurately adjust or tune the density characteristics of the sheet.

Moreover, it was observed in these processes that this reduced thickness of the produced fiber cement sheet increases again upon leaving the belt press, a phenomenon also referred to as a “spring-back” of the thickness of the sheet. The spring-back obviously causes difficulties in producing sheets without any damages, let alone with accurate and predefined densities and dimensions.

In U.S. Pat. No. 6,702,966, a vacuum pump at a single under-pressure of about 34 kPa was used for dewatering fiber cement products. However, the product first has to be subjected to a pressure plate in order to sufficiently level out or smoothen the surface of the freshly deposited fiber cement slurry. The use of such a pressure plate is not very effective in obtaining the correct density and dimensions as explained above (spring-back). Furthermore, this pressing system is relatively complex since it has to be performed at a specific inclination angle to avoid on the one hand the generation of bubbles in the slurry and on the other hand the stripping of the product from the belt.

U.S. Pat. No. 4,194,946, on the other hand, discloses a process where underneath the entire conveyor belt, a plurality of suction boxes are installed, which suction boxes are driven to move forward with the same velocity as the conveyor belt. However, this system typically loses its accuracy when operating at an industrial scale. In fact, only the slightest difference between the velocity of the transport belt and the suction boxes results in damaged or teared products.

In view of the above, there remains a need for alternative and/or improved processes that can be performed on an industrial scale for the production of monolithic fiber cement sheets, having an accurate pre-defined density and dimensions and having a uniform and homogenous dispersion of fibers in the matrix such that sufficient strength in all directions is ensured . . . .

### SUMMARY OF THE INVENTION

An object of the present invention is to provide processes for producing monolithic fiber cement sheets with improved properties.

In this regard, the present inventors have developed a novel industrial process for the production of monolithic fiber cement sheets having sufficient strength in all directions, having the desired density and having a predetermined length and thickness.

In particular, it has been found that continuously discharging a fiber cementitious slurry as such, i.e. a cementitious slurry with fibers dispersed therein, on a production belt avoids a consistent orientation of the fibers in the cement slurry because the fibers are distributed uniformly in all different directions within the cementitious slurry. The inventors have found that by discharging a mixture of cementitious slurry already comprising fibers, the overall strength of the resulting sheet is improved as compared to sheets where cementitious slurry and fibers are separately discharged (i.e. by means of two or more different discharging devices) and thus not mixed prior to the dischargement. Additionally, it has surprisingly been found that by using a water-permeable transport belt for removing the excess of water from the fiber cement sheet, both the thickness and the density of the sheet can be accurately tuned, without resulting in a spring-back of the thickness of the sheet at the end of the production process.

In a first aspect, the present invention provides processes for the production of fiber cement sheets, at least comprising the steps of:

(a) providing a cementitious slurry comprising fibers,
(b) continuously discharging the slurry on an endless water-permeable transport belt,
(c) removing excess of water from the slurry through the water-permeable transport belt to form a fiber cement sheet with a predetermined thickness.

In particular embodiments, the present invention provides processes for the production of fiber cement sheets, at least comprising the steps of:

(a) providing a cementitious slurry comprising fibers by mixing together a cementitious slurry with fibers with a mixing device in a container,
(b) continuously discharging the slurry on an endless water-permeable transport belt,
(c) removing excess of water from the slurry through the water-permeable transport belt to form a fiber cement sheet with a predetermined thickness.

In particular embodiments of the processes according to the invention, the fibers have a length of between about 0.2 mm and about 10 mm, preferably between about 0.5 mm and about 10 mm, more preferably between about 0.5 mm and 5 mm, most preferably between 0.5 mm and about 4.5 mm.

In further particular embodiments of the processes according to the invention, the fibers are cellulose fibers.

In certain particular embodiments of the processes according to the invention, the fibers are hardwood cellulose fibers having a length of between about 0.5 mm and about 3.0 mm. In further particular embodiments, the fibers are softwood cellulose fibers having a length of between about 2 mm and about 4.5 mm. In yet further particular embodiments, the fibers are a mixture of different types of cellulose fibers having a length of between about 0.5 mm and about 4.5 mm.

In certain particular embodiments, the step of removing excess of water from the slurry through the water-permeable transport belt is performed by suction. In yet further particular embodiments, the step of removing excess of water from the slurry by means of suction through the water-permeable transport belt takes place in at least three consecutive zones with different under-pressures. In particular embodiments, the under-pressure in a first of the zones may range between about 15 and about 65 mbar. In further particular embodiments, the under-pressure in a second of the zones may range between about 65 and about 200 mbar. In yet further particular embodiments, the under-pressure in a third of the zones may range between about 200 to about 550 mbar. In yet further particular embodiments, the under-pressure in a first of these zones ranges between about 15 and about 65 mbar and/or the under-pressure in a second of these zones ranges between about 65 and about 200 mbar and/or the under-pressure in a third of these zones ranges between about 200 to about 550 mbar. In still further particular embodiments, the under-pressure in a first of the zones ranges between about 15 and about 65 mbar and in a second of the zones ranges between about 65 and about 200 mbar and in a third of the zones ranges between about 200 to about 550 mbar. In yet further particular embodiments of the processes of the invention, the freshly deposited fiber cement slurry layer is first subjected to a first zone on the water-permeable conveyor belt, which is characterized by an under-pressure between about 15 and about 65 mbar, and subsequently subjected to a second zone on the water-permeable conveyor belt, which is characterized by an under-pressure between about 65 and about 200 mbar, and finally subjected to a third zone on the water-permeable conveyor belt which is characterized by an under-pressure between about 200 and about 550 mbar, in that particular order.

The present inventors have found that by subjecting the product in preparation to this specific combination of consecutive zones having increasing under-pressures, an optimal dewatering of the fiber cement sheet can be achieved. In fact, if the fiber cement slurry layer is subjected to only one single under-pressure zone, the under-pressure is either too low to have an optimal dewatering effect or too high, which typically causes undesirable cracks, bubbles and wrinkles in the fiber cement sheet. The inventors have now found that by creating a gradient of increasing under-pressures, the product is slowly and carefully subjected to increasing under-pressures, thereby avoiding damage to the final product while still allowing sufficient dewatering.

It will be understood that the processes of the invention will also have the same beneficial effects when more than three consecutive under-pressure zones are applied, as long as the under-pressures increase in the machine direction (i.e. production direction), thereby ensuring that the product is gradually subjected from a low under-pressure (i.e. at least 20 mbar) to a high under-pressure (i.e. at most 900 mbar).

In further particular embodiments, the step of removing excess of water from the slurry through the water-permeable transport belt is additionally performed by applying mechanical force. In yet further particular embodiments, the step of removing excess of water from said slurry through said water-permeable transport belt is additionally performed by applying mechanical force by means of one or more mechanical belt presses, such as but not limited to at least one, such as for instance one, mechanical belt press.

In particular embodiments, the processes according to the invention further comprise the step of spraying a hydrophobic substance onto the discharged fiber cement slurry and/or onto the obtained fiber cement sheet.

In particular embodiments, the step of continuously discharging the fiber cement slurry on an endless water-permeable transport belt is performed by means of one or more flow-on distribution devices through which the slurry is continuously dispensed on the belt.

In more particular embodiments, the step of continuously discharging the fiber cement slurry on an endless water-permeable transport belt is performed by means of one or more spattering distribution devices, through which the slurry is continuously and randomly spattered on the belt.

In yet further particular embodiments, the step of continuously discharging the fiber cement slurry on an endless water-permeable transport belt is performed by means of one or more spraying distribution devices, through which the slurry is continuously and randomly sprayed on the belt.

In particular embodiments of the processes according to the invention, the amount of fiber cementitious slurry that is discharged on the water-permeable transport belt is controlled.

In more particular embodiments of the processes according to the invention, the predetermined thickness of the dewatered fiber cement sheet ranges between about 8 mm and about 200 mm.

In particular embodiments, the processes according to the invention further comprise the step of cutting the fiber cement layer obtained in step (c) to a predetermined length to form a fiber cement sheet with a predetermined thickness and a predetermined length.

In particular embodiments, the processes according to the invention further comprise the step of curing the obtained fiber cement sheet.

In a second aspect, the present invention provides fiber cement products, such as fiber cement sheets, obtainable by the processes according to the invention.

In a third aspect, the present invention provides apparatuses for continuous production of fiber cement sheets, at least comprising:

(i) one or more fiber cement slurry distribution devices, each of which is connected to a fiber cement source for continuously discharging a fiber cement slurry on an endless water-permeable transport belt, and
(ii) an endless water-permeable transport belt onto which the slurry is discharged.

In particular embodiments, the apparatuses of the present invention comprise at least the following steps:
(i) one or more mixing devices comprising at least a mixer and a container for mixing a cementitious slurry with fibers so as to obtain a fiber cement slurry;
(ii) one or more fiber cement slurry distribution devices, each of which is connected to a fiber cement source for continuously discharging a fiber cement slurry on an endless water-permeable transport belt, and
(iii) an endless water-permeable transport belt onto which the fiber cement slurry is discharged.

In particular embodiments, the apparatuses according to the present invention at least comprise:

(i) one or more distribution devices connected to a fiber cement source for continuously discharging a fiber cement slurry on an endless water-permeable transport belt,
(ii) an endless water-permeable transport belt onto which the fiber cement slurry is discharged, and
(iii) one or more dewatering devices installed adjacent to or near the water-permeable belt so as to achieve, facilitate and/or accelerate the removal of excess of water from the fiber cement slurry thereby forming a fiber cement sheet with a predetermined thickness.

In further particular embodiments, the apparatuses according to the present invention at least comprise:

(i) one or more mixing devices comprising at least a mixer and a container for mixing a cementitious slurry with fibers so as to obtain a fiber cement slurry;
(ii) one or more distribution devices connected to said one or more mixing devices for continuously discharging a fiber cement slurry on an endless water-permeable transport belt,
(ii) an endless water-permeable transport belt onto which the fiber cement slurry is discharged, and
(iii) one or more dewatering devices installed adjacent to or near the water-permeable belt so as to achieve, facilitate and/or accelerate the removal of excess of water from the fiber cement slurry thereby forming a fiber cement sheet with a predetermined thickness.

In further particular embodiments, the one or more dewatering devices installed adjacent to or near the water-permeable belt are chosen from the group consisting of one or more mechanical belt presses and one or more vacuum pumps. In yet further particular embodiments, the one or more dewatering devices installed adjacent to or near the water-permeable belt are one or more mechanical belt presses and one or more vacuum pumps, each of which dewatering device may be installed in any configuration or order with respect to another dewatering device. In more particular embodiments, the one or more dewatering devices installed adjacent to or near the water-permeable belt are at least one mechanical belt press and at least three vacuum pumps, each of which dewatering device may be installed in any configuration or order with respect to another dewatering device.

In yet further particular embodiments, said one or more dewatering devices may be installed adjacent to or near the water-permeable belt in the following consecutive order when looking in the machine direction (which is the same as the direction in which the conveyor belt moves and which is the same as the production direction, starting from the fresh fiber cement slurry layer proceeding to the finalized fiber cement sheet): (i) at least three vacuum pumps having increasing under-pressures, thereby creating a first zone on the water-permeable conveyor belt, which is characterized by an under-pressure between about 15 and about 65 mbar, and subsequently a second zone on the water-permeable conveyor belt, which is characterized by an under-pressure between about 65 and about 200 mbar, and finally a third zone on the water-permeable conveyor belt which is characterized by an under-pressure between about 200 and about 550 mbar, and (ii) a mechanical belt press or pressure plate. In further particular embodiments, a fourth vacuum pump may be installed after the third vacuum pump and before the mechanical press or pressure plate, thereby creating a fourth zone, which is characterized by an under-pressure between about 550 and about 850 mbar.

In alternative particular embodiments, said one or more dewatering devices may be installed adjacent to or near the water-permeable belt in the following consecutive order when looking in the machine direction: (i) a mechanical belt press or pressure plate, and (ii) at least three vacuum pumps having increasing under-pressures, thereby creating a first zone on the water-permeable conveyor belt, which is characterized by an under-pressure between about 15 and about 65 mbar, and subsequently a second zone on the water-permeable conveyor belt, which is characterized by an under-pressure between about 65 and about 200 mbar, and finally a third zone on the water-permeable conveyor belt which is characterized by an under-pressure between about 200 and about 550 mbar. In further particular embodiments, a fourth vacuum pump may be installed after the third vacuum pump, thereby creating a fourth zone, which is characterized by an under-pressure between about 550 and about 850 mbar.

In yet other particular embodiments, said one or more dewatering devices may be installed adjacent to or near the water-permeable belt above each other, i.e. a mechanical belt press or pressure plate may be installed above the water-permeable conveyor belt at a certain zone when looking in the machine direction, and at least three vacuum pumps having increasing under-pressures may be installed underneath the water-permeable conveyor belt at that same zone or at least in a zone overlapping with that same zone, wherein a first vacuum pump creates an under-pressure between about 15 and about 65 mbar, and subsequently a second vacuum pump creates an under-pressure between about 65 and about 200 mbar, and finally a third vacuum pump creates an under-pressure between about 200 and about 550 mbar, viewing in the machine direction. In further particular embodiments, a fourth vacuum pump may be installed after the third vacuum pump, thereby creating an under-pressure between about 550 and about 850 mbar. In this configuration, the mechanical press or pressure plate and the vacuum pumps operate in the same zone or at overlapping zones of the water-permeable conveyor belt. In further particular embodiments, a fourth vacuum pump may be installed after the third vacuum pump, thereby creating a fourth zone, which is characterized by an under-pressure between about 550 and about 850 mbar.

In particular embodiments, the one or more fiber cement distribution systems may be chosen from the group consisting of one or more flow-on distribution devices through which the slurry is continuously dispensed on the belt, one or more spattering distribution devices, through which the slurry is continuously and randomly spattered on the belt and one or more spraying systems, through which the slurry is continuously and randomly sprayed onto the belt. In yet further particular embodiments, the one or more slurry distribution devices are one or more flow-on systems through which the fiber cement slurry is continuously dispensed on the belt and one or more spattering systems, through which the slurry is continuously and randomly spattered on the belt and one or more spraying systems, through which the slurry is continuously and randomly sprayed on the belt. In still further particular embodiments, the one or more distribution devices are one or more flow-on systems through which the slurry is continuously dispensed on the belt and/or one or more spattering distribution systems, through which the slurry is continuously and randomly spattered on the belt and/or one or more spraying systems, through which the slurry is continuously and randomly sprayed on the belt. In more particular embodiments, the one or more slurry distribution devices are one or more flow-on systems through which the slurry is continuously dispensed on the belt.

In a fourth aspect, the present invention provides uses of the fiber cement products and sheets obtainable by the processes according to the present invention in the building industry. In particular embodiments, the fiber cement sheets produced by the processes of the present invention can be used to provide an outer surface to walls, both internal as well as external a building or construction, e.g. as façade plate, siding, etc.

The independent and dependent claims set out particular and preferred features of the invention. Features from the dependent claims may be combined with features of the independent or other dependent claims, and/or with features set out in the description above and/or hereinafter as appropriate.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a schematic view of an apparatus for performing the processes as described herein according to one specific embodiment of the invention, wherein the fiber cement slurry is discharged using a flow-on distribution device and wherein the step of removing excess of water is performed consecutively by means of suction followed by mechanical pressure.

FIG. 2 is a schematic view of an apparatus for performing the processes as described herein according to one specific embodiment of the invention, wherein the fiber cement slurry is discharged using a flow-on distribution device and wherein the step of removing excess of water is performed simultaneously by means of suction and mechanical pressure.

FIG. 3 is a schematic view of an apparatus for performing the processes as described herein according to one specific embodiment of the invention, wherein the fiber cement slurry is discharged using a flow-on distribution device and wherein the step of removing excess of water is first performed by means of suction and subsequently performed through a combination of suction and mechanical pressure.

FIG. 4 is a schematic view of an apparatus for performing the processes as described herein according to one specific embodiment of the invention, wherein the fiber cement slurry is discharged using a spattering distribution device and wherein the step of removing excess of water is performed consecutively by means of suction followed by mechanical pressure.

FIG. 5 is a schematic view of an apparatus for performing the processes as described herein according to one specific embodiment of the invention, wherein the fiber cement slurry is discharged using a spraying distribution device and wherein the step of removing excess of water is performed consecutively by means of suction followed by mechanical pressure.

FIG. 6 is a schematic view of an apparatus for performing the processes as described herein according to one specific embodiment of the invention, wherein two different compositions of fiber cement slurry are discharged at two different positions on the felt using a flow-on and a spattering distribution device, respectively, and wherein the step of removing excess of water is performed consecutively by means of suction followed by mechanical pressure, respectively.

The same reference signs refer to the same, similar or analogous elements in the different figures.
1 Water-permeable transport belt
2 Mechanical press
3 Vacuum boxes having increasing under-pressures in the machine direction (see arrow)
4 Flow-on fiber cement distribution device
5 Flow of fiber cement slurry
6 Spattering fiber cement distribution device
7 Spatters of fiber cement slurry
8 Spraying fiber cement distribution device
9 Spray of fiber cement slurry
10 Arrow indicating the machine direction (i.e. direction in which fiber cement sheets are produced)
11 Vacuum pumps

### DESCRIPTION OF ILLUSTRATIVE EMBODIMENTS

The present invention will be described with respect to particular embodiments.

It is to be noted that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, reference to “one embodiment” or “an embodiment” are made. Such references indicate that a particular feature, described in relation to the embodiment is included in at least one embodiment of the present invention. Thus, appearances of the phrases “in one embodiment” or “in an embodiment” in various places throughout this specification are not necessarily all referring to the same embodiment, though they could. Furthermore, the particular features or characteristics may be combined in any suitable manner in one or more embodiments, as would be apparent to one of ordinary skill in the art.

The following terms are provided solely to aid in the understanding of the invention.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical ranges by endpoints includes all numbers and fractions subsumed within the respective ranges, as well as the recited endpoints.

The term “about” as used herein when referring to a measurable value such as a parameter, an amount, a temporal duration, and the like, is meant to encompass variations of +/−10% or less, preferably +/−5% or less, more preferably +1-1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The terms “(fiber) cementitious slurry”, “(fiber) cement slurry”, “fiber cementitious slurry” or “fiber cement slurry” as referred to herein generally refer to slurries at least comprising water, fibers and cement. The fiber cement slurry as used in the context of the present invention may also further comprise other components, such as but not limited to, limestone, chalk, quick lime, slaked or hydrated lime, ground sand, silica sand flour, quartz flour, amorphous silica, condensed silica fume, microsilica, metakaolin, wollastonite, mica, perlite, vermiculite, aluminum hydroxide, pigments, anti-foaming agents, flocculants, and other additives.

“Fiber(s)” present in the fiber cement slurry as described herein may be for example process fibers and/or reinforcing fibers which both may be organic fibers (typically cellulose fibers) or synthetic fibers (polyvinylalcohol, polyacrilonitrile, polypropylene, polyamide, polyester, polycarbonate, etc.).

“Cement” present in the fiber cement slurry as described herein may be for example but is not limited to Portland cement, cement with high alumina content, Portland cement of iron, trass-cement, slag cement, plaster, calcium silicates formed by autoclave treatment and combinations of particular binders. In more particular embodiments, cement in the products of the invention is Portland cement.

The term “water-permeable” as used herein when referring to a water-permeable (region of a) transport belt generally means that the material of which the water-permeable (region of the) belt is made allows water to flow through its structure to a certain extent.

The “water-permeability” as used herein when referring to the water-permeability of a (region of a) transport belt generally refers to the extent or degree to which the material of which the water-permeable (region of the) belt is made, allows water to flow through its structure. Suitable materials for water-permeable transport belts are known to the person skilled in the art, such as but not limited to felts.

The terms “predetermined” and “predefined” as used herein when referring to one or more parameters or properties generally mean that the desired value(s) of these parameters or properties have been determined or defined beforehand, i.e. prior to the start of the process for producing the products that are characterized by one or more of these parameters or properties.

A “(fiber cement) sheet” or “fiber cement sheet” or “sheet” as interchangeably used herein, and also referred to as a panel or a plate, is to be understood as a flat, usually rectangular element, a fiber cement panel or fiber cement sheet being provided out of fiber cement material. The panel or sheet has two main faces or surfaces, being the surfaces with the largest surface area. The sheet can be used to provide an outer surface to walls, both internal as well as external a building or construction, e.g. as façade plate, siding, etc.

The invention will now be further explained in detail with reference to various embodiments. It will be understood that each embodiment is provided by way of example and is in no way limiting to the scope of the invention. In this respect, it will be clear to those skilled in the art that various modifications and variations can be made to the present invention without departing from the scope or spirit of the invention. For instance, features illustrated or described as part of one embodiment, can be used in another embodiment to yield a still further embodiment. Thus, it is intended that the present invention covers such modifications and variations as encompassed within the scope of the appended claims and equivalents thereof.

The present invention provides processes for the production of fiber cement sheets with improved structural, physical and mechanical properties. Typically, in the processes for producing fiber cement sheets according to the present invention, the various starting component materials are mixed, cured and/or otherwise processed according to any standard method generally known in the art.

However, the present inventors have found that by using one or more fiber cement distribution systems for continuously and randomly discharging pre-mixed fiber cementitious slurry (as defined herein) directly onto the production belt, a random orientation of fibers within the cement slurry is achieved, which significantly improves the overall strength of the resulting fiber cement sheet. In particular, it has been found that continuously discharging a fiber cementitious slurry as such, i.e. a cementitious slurry with fibers dispersed therein, on a production belt avoids a consistent orientation of the fibers in the cement slurry because the fibers are distributed uniformly in all different directions within the cementitious slurry. The inventors have found that by discharging a mixture of cementitious slurry already comprising fibers, the overall strength of the resulting sheet is improved as compared to sheets where cementitious slurry and fibers are separately discharged (i.e. by means of two or more different discharging devices) and thus not mixed prior to the dischargement.

Additionally and even more importantly, introducing the step of dewatering the discharged fiber cement layer by making use of a water-permeable transport belt allows to adjust both the thickness and the density of the sheet in an accurate manner.

More specifically, the present inventors have found that by subjecting the product in preparation to a specific combination of consecutive zones on the water-permeable conveyor belt, which zones are characterized by increasing under-pressures, an optimal dewatering of the fiber cement sheet can be achieved. In fact, if the fiber cement slurry layer is subjected to only one single under-pressure zone, the under-pressure is either too low to have an optimal dewatering effect or too high, which typically causes undesirable cracks, bubbles and wrinkles in the fiber cement sheet. The inventors have now found that by creating a gradient of increasing under-pressures, damage to the final product is avoided while still allowing sufficient dewatering. In a first aspect, the processes according to the present invention thus at least comprise the steps of:

(a) providing a cementitious slurry comprising fibers,
(b) continuously discharging the slurry on an endless water-permeable transport belt,
(c) removing excess of water from the slurry through the water-permeable transport belt to form a fiber cement sheet with a predetermined thickness.

The first step of providing a fiber cement slurry (as defined herein) can be performed according to any method known in the art for preparing fiber cement slurries, essentially consisting of at least water, cement and fibers.

In particular embodiments of the present invention, the fiber cement slurry can be provided by one or more sources of at least cement, water and fibers.

In certain specific embodiments, these one or more sources of at least cement, water and fibers are operatively connected to a continuous mixing device constructed so as to form a cementitious fiber cement slurry.

In certain specific embodiments, the fibers cementitious slurry is formed by putting together in a container, a barrel or a recipient at least water, cement and fibers and mixing these ingredients within the container, barrel or recipient with a continuous mixing device such that the fibers are uniformly and homogenously dispersed within the liquid cementitious slurry.

In particular embodiments, when using cellulose fibers or the equivalent of waste paper fibers, a minimum of about 2 wt %, such as at least about 3 wt %, such as at least about 4 wt % of these cellulose fibers (compared to the total initial dry weight of the slurry) may be used. In further particular embodiments, when exclusively cellulose fibers are used, between about 4 wt % to about 12 wt %, such as more particularly, between about 7 wt % and about 10 wt % of these cellulose fibers (compared to the total initial dry weight of the slurry) may be used. If cellulose fibers are replaced by short mineral fibers such as rock wool, it is most advantageous to replace them in a proportion of 1.5 to 3 times the weight, in order to maintain approximately the same content per volume. In long and cut fibers, such as glass fiber rovings or synthetic high-module fibers, such as polypropylene, polyvinyl acetate, polycarbonate or acrylonitrile fibers the proportion can be lower than the proportion of the replaced cellulose fibers. The fineness of the fibers (measured in Shopper-Riegler degrees) is in principle not critical to the processes of the invention. Yet in particular embodiments, where autoclave-cured fiber cement products are envisaged, it has been found that a range between about 15 DEG SR and about 45 DEG SR can be particularly advantageous for the processes of the invention. In alternative embodiments, where air-cured fiber cement products are envisaged, it has been found that a range between about 35 DEG SR and about 75 DEG SR can be particularly advantageous for the processes of the invention.

The second step of continuously discharging the fiber cement slurry on an endless water-permeable belt can be performed by any method known in the art as long as the fiber cement slurry is discharged in a manner which does not induce or provoke a preferential orientation of the fibers within the slurry. Indeed, it is an object of the present invention to provide processes for producing fiber cement sheets which have an improved strength, which can in particular be achieved by a random orientation of the fibers throughout the entire fiber cement structure.

In this regard, the present inventors have developed a novel industrial process for the production of monolithic fiber cement sheets having sufficient strength in all directions, and moreover having the desired density and having a predetermined length and thickness.

In particular, it has been found that continuously discharging a fiber cementitious slurry as such on a production belt avoids a consistent orientation of the fibers in the cement slurry and improves the overall strength of the resulting sheet.

In certain particular non-limiting embodiments, the step of continuously discharging the fiber cement slurry on the belt can be performed by producing a flow of cement slurry onto the transport belt using one or more flow-on distribution devices. Such flow-on devices have at least one outlet, allowing the slurry to flow continuously onto the transport belt. In particular embodiments, the one or more outlets of the device are circularly or rectangularly shaped. In certain particular embodiments, the flow-on devices further comprise one or more inlets, which are directly or indirectly operatively connected with a source of fiber cement slurry. Sources of fiber cement slurry can for example be but are not limited to one or more continuous fiber cement feeding systems or one or more continuous mixing devices constructed so as to form a cementitious fiber cement slurry and means for indirectly or directly feeding the slurry to one or more dispensing devices.

In yet further particular embodiments, the length of the one or more flow-on devices for the continuous discharge of the cementitious slurry is at least 2.5 times the total width of the one or more inlets, such as at least 3.0 times, more particularly at least 3.5 times, such as at least 4.0 times, for instance at least 4.5 times or even at least 5.0 times the total width of the one or more inlets.

In certain particular embodiments, the one or more flow-on distribution devices comprise at least one part with continuously moving walls. In further particular embodiments, the one or more distribution devices are internally partitioned by internal walls, either in only certain parts of the internal space of the device or throughout the entire internal space of the device.

In certain further particular embodiments, the step of continuously discharging the fiber cement slurry on the belt can be performed through at least one distribution device which continuously and randomly spatters or sprays (droplets of) fiber cement slurry onto the transport belt.

In these particular embodiments, the step of continuously discharging the fiber cement slurry on the belt can be performed through one or more agitated brush systems, which continuously and randomly spatter (droplets of) fiber cement slurry onto the transport belt.

According to these particular embodiments, one or more agitated brush-like devices, such as bristle-brush-like devices, are partly or entirely in contact with the fiber cement slurry, which is provided by one or more sources of fiber cement slurry. In this way, droplets of fiber cement slurry stick to and are picked up by the bristles of the one or more brush-like devices. Through agitation of the one or more brush-like devices, the droplets of fiber cement slurry are discharged from the different bristles of the one or more brush-like devices onto the transport belt. Thus, according to these particular embodiments, a plurality of bristles are used in a brush-like configuration, which is agitated (e.g. rotated, vibrated, etc.) so as to flick small droplets of the fiber cement slurry from the supply source to the transport belt. Such distribution devices may be in a brush form (such as a bristle-brush form) in roll or cylindrical configuration, or in a brush form (such as a bristle-brush form) in an upstanding array which, when agitated, flicks the pellets or droplets of fiber cement slurry from the edge of the bristles onto the transport belt.

In still further particular embodiments, the step of continuously discharging the fiber cement slurry on the belt can be performed through one or more spraying systems, which continuously and randomly spray (droplets of) fiber cement slurry, provided by one or more sources of fiber cement slurry, onto the transport belt. Characteristics of spraying devices suitable for use in the present invention are not critical to the present invention as long as such devices are configured to discharge fiber cement slurry droplets from an atomizer or other device (part) onto the transport belt. The spraying devices for use in the present invention are known to the person skilled in the art and can be developed using routine techniques.

In yet further particular embodiments, the step of continuously discharging the fiber cement slurry on the transport belt can be performed through any suitable combination of the one or more distribution systems as described herein.

Thus, in particular embodiments, the step of continuously discharging the fiber cement slurry onto the belt can be performed consecutively by one or more flow-on distribution devices, continuously producing a fiber cement slurry flow, and/or one or more distribution devices, which continuously and randomly sputter or spray (droplets of) fiber cement slurry onto the transport belt.

As a non-limiting example of these embodiments, the step of continuously discharging the fiber cement slurry on the belt can be performed consecutively by one or more flow-on distribution devices, which continuously and randomly produce a flow of cement slurry onto the transport belt, and/or one or more spattering distribution systems and/or one or more spraying distribution devices, which continuously and randomly spatter and/or spray, respectively, (droplets of) fiber cement slurry onto the transport belt.

In certain particular embodiments, the step of continuously discharging the fiber cement slurry on the belt can be performed consecutively by continuously and randomly producing a flow of cement slurry onto the transport belt by means of one or more flow-on dispensing devices, followed continuously and randomly spattering (droplets of) fiber cement slurry onto the transport belt by means of one or more spattering distribution systems. It will be understood that in these specific embodiments, the step of discharging fiber cement slurry can also be performed by first continuously and randomly spattering (droplets of) fiber cement slurry onto the transport belt using one or more spattering distribution systems, and then continuously and randomly producing a flow of cement slurry onto the transport belt by using one or more flow-on distribution devices.

In certain other particular embodiments, the step of continuously discharging the fiber cement slurry on the belt can be performed consecutively by continuously and randomly producing a flow of cement slurry onto the transport belt by means of one or more flow-on distribution devices, followed continuously and randomly spraying (droplets of) fiber cement slurry onto the transport belt by means of one or more spraying systems. It will be understood that in these specific embodiments, the step of discharging fiber cement slurry can also be performed by first continuously and randomly spraying (droplets of) fiber cement slurry onto the transport belt using one or more spraying systems, and then continuously and randomly producing a flow of cement slurry onto the transport belt by using one or more flow-on dispensing devices.

In further particular embodiments, the step of continuously discharging the fiber cement slurry on the belt can be performed consecutively by continuously and randomly producing a flow of cement slurry onto the transport belt by means of one or more flow-on distribution devices, followed by continuously and randomly spattering (droplets of) fiber cement slurry onto the transport belt by means of one or more spattering distribution systems, further followed by continuously and randomly spraying (droplets of) fiber cement slurry onto the transport belt by means of one or more spraying systems.

It will be understood that in these specific embodiments, the step of discharging fiber cement slurry can also be performed by consecutively producing a flow of cement slurry onto the transport belt by means of one or more flow-on distribution devices, followed by continuously and randomly spraying (droplets of) fiber cement slurry onto the transport belt by means of one or more spraying systems, further followed by continuously and randomly spattering (droplets of) fiber cement slurry onto the transport belt by means of one or more spattering distribution systems.

Alternatively, in these specific embodiments, the step of discharging fiber cement slurry can also be performed by first continuously and randomly spraying (droplets of) fiber cement slurry onto the transport belt using one or more spraying systems, and then continuously and randomly either (i) first producing a flow of cement slurry onto the transport belt by using one or more flow-on distribution devices and then continuously and randomly spattering (droplets of) fiber cement slurry onto the transport belt using one or more spattering distribution systems or (ii) first continuously and randomly spattering (droplets of) fiber cement slurry onto the transport belt using one or more spattering distribution systems and then producing a flow of cement slurry onto the transport belt by using one or more flow-on distribution devices.

Yet in an alternative scenario according to these specific embodiments, the step of discharging fiber cement slurry can also be performed by first continuously and randomly spattering (droplets of) fiber cement slurry onto the transport belt using one or more spattering distribution systems, and then continuously and randomly either (i) first producing a flow of cement slurry onto the transport belt by using one or more flow-on distribution devices and then continuously and randomly spraying (droplets of) fiber cement slurry onto the transport belt using one or more spraying systems or (ii) first continuously and randomly spraying (droplets of) fiber cement slurry onto the transport belt using one or more spraying systems and then producing a flow of cement slurry onto the transport belt by using one or more flow-on distribution devices.

In the processes of the present invention, in order to obtain a fiber cement sheet with predetermined dimensions (i.e. thickness, length) and density, the amount of cementitious slurry that is discharged on the water-permeable transport belt per time unit is controlled but will depend on different parameters, such as the type and predetermined dimensions of the final product to be made and the specific composition of the fiber cement slurry. It will be clear that the amount of cementitious slurry that is to be discharged on the water-permeable transport belt per time unit in order to obtain a certain fiber cement product can be determined by the skilled person using routine techniques.

In particular embodiments, the one or more distribution systems as described herein can be used in the processes of the invention for discharging fiber cement slurry onto a water-permeable transport belt. In further particular embodiments, the one or more distribution systems as described herein can be used in the processes of the invention in order to discharge either one or more of the same compositions of fiber cement slurry or one or more different compositions of fiber cement slurry. In further particular embodiments, the one or more distribution systems as described herein can be used in the processes of the invention in order to discharge one or more of the same fiber cement compositions and/or one or more different fiber cement compositions and/or one or more additional compositions other fiber cement slurry compositions.

In particular embodiments, in those processes where the step of discharging the fiber cement slurry is performed by consecutively using at least two or more distribution systems as described herein, the resulting fiber cement sheet can be two-layered or multi-layered, respectively.

In particular embodiments, in those processes where the step of discharging the fiber cement slurry is performed by consecutively using at least two distribution systems, each of which distributes the same fiber cement composition, the resulting fiber cement sheet will comprise at least two layers of the same fiber cement composition.

In other more particular embodiments, in those processes where the step of discharging the fiber cement slurry is performed by consecutively using at least two distribution systems, each of which distributes a different fiber cement composition, the resulting fiber cement sheet will comprise at least two layers of a different fiber cement composition.

In yet further particular embodiments, in those processes where the step of discharging the fiber cement slurry is performed by consecutively using at least two distribution systems, each of which dispenses a fiber cement composition and a composition other than a fiber cement composition, respectively, the resulting fiber cement sheet will comprise at least one layer of fiber cement composition and at least one layer of a composition other than a fiber cement composition.

In yet more particular embodiments, in those processes where the step of discharging the fiber cement slurry is performed by consecutively using at least three distribution systems, each of which dispenses a first fiber cement composition, a second fiber composition, which is the same or different from the first, and a composition other than a fiber cement composition, respectively, the resulting fiber cement sheet will comprise at least two layers of fiber cement composition, which are either the same or different from each other, and at least one layer of a composition other than a fiber cement composition.

In this manner, by making use of two or more consecutively installed distribution systems as described herein, fiber cement sheets comprising two or more layers, each of which layer has a particular composition that can be predetermined, can be manufactured by the processes of the invention.

The processes according to the present invention at least comprise the step of continuously discharging the slurry on an endless water-permeable (as defined herein) transport belt.

In particular embodiments, after being discharged, the fiber cement slurry can optionally be treated in various ways. For instance, the fiber cement slurry can be pressed by mechanical means, such as by a (cylindrical) belt press, so as to obtain a flat layer of fiber cement slurry.

Alternatively, or additionally, the fiber cement slurry can be treated with various agents so as to improve or alter its structure or properties. For example, the fiber cement slurry can be treated with a hydrophobic agent prior to being placed onto the water-permeable transport belt.

The water-permeable belt for use in the present invention can be made of any water-permeable material suitable for transport belts as commonly known to the person skilled in the art, as long as this material cannot be affected, damaged or harmed (e.g. through corrosion) upon contact with a fiber cement slurry composition. Suitable materials for water-permeable transport belts for use in the present invention are known to the skilled person and are for example but not limited to felt.

In particular embodiments, the water-permeable belt as used herein is an endless belt, which is completely water-permeable, i.e. water-permeable over its entire surface.

In other particular embodiments, the water-permeable belt as used herein is an endless belt, which is partly water-permeable, i.e. water-permeable at one or more regions of the belt surface.

In yet other particular embodiments, the water-permeable belt as used herein represents one or more endless belts, placed in a consecutive arrangement, each of which one or more belts are either partly or completely water-permeable, i.e. water-permeable at their entire surface or at one or more specific regions of their surface, respectively.

In the processes of the present invention, the fiber cement slurry is continuously discharged by one or more dispensing systems (as described herein), either directly or indirectly, onto a water-permeable transport belt.

Thus, in particular embodiments of the present invention, the fiber cement slurry is discharged by one or more dispensing systems directly onto the surface of a water-permeable transport belt.

In other particular embodiments, the fiber cement slurry is discharged by one or more dispensing systems indirectly onto a water-permeable transport belt. In these specific embodiments, the fiber cement slurry is first discharged by one or more distribution systems onto a surface other than a water-permeable transport belt, such as for example but not limited to a transport belt which is not water-permeable, and only then further transported, deposited, or placed onto a water-permeable transport belt.

The processes according to the present invention further at least comprise the step of removing excess of water from the slurry through a water-permeable transport belt to form a fiber cement sheet with a predetermined thickness and/or with a predetermined density.

In the known processes for producing fiber cement sheets, the step of evacuating water from the slurry typically results in sheets with varying dimensions. These known processes indeed lack the possibility of accurately predetermining or predefining the thickness and density characteristics of the sheet to be produced.

The present inventors have now found that by removing the excess of water from the fiber cement sheet through a water-permeable transport belt, both the thickness and the density of the sheet can be accurately tuned.

Removing the excess of water from the fiber cement sheet through a water-permeable transport can be performed by simply discharging or placing the fiber cement slurry onto the water-permeable belt during a certain period of time, upon which the water will flow down out of the fiber cement structure and subsequently pass through the structure of the water-permeable belt under influence of the force of gravity.

In certain particular embodiments, in order to further achieve, accelerate or facilitate the step of removing the excess of water from the fiber cement slurry, additional or alternative forces can be applied.

In specific embodiments, mechanical forces can be used to press together the fiber cement slurry, so as to squeeze the water out of the pores and passages in the fiber cement structure and thereby increasing the density thereof. Mechanical forces can be applied by using in principle any means suitable therefor and known to the skilled person. For instance, a mechanical belt press, such as a flat, cubic, cylindrical etc. mechanical belt press, can be used to remove the excess of water from the fiber cement slurry. By allowing the excess of water to escape through a water-permeable transport belt, not only the thickness but also the density of the fiber cement product can be adjusted. The fiber cement slurry can in principle be pressed together against the water-permeable belt in any possible direction (i.e. up, down, left, right etc.). In particular embodiments, however, the fiber cement slurry is pressed together against the surface of the water-permeable belt in the vertically downward direction, i.e. in substantially the same direction as that of the force of gravity.

In alternative or additional particular embodiments, physical forces can be used to remove the excess of water from the pores and passages in the fiber cement structure and thereby increasing the density thereof. For instance, in certain particular embodiments, suction can be used to remove the excess of water from the pores and passages in the fiber cement structure thereby increasing the density thereof. For example, one or more vacuum pumps can be used to remove the excess of water from the fiber cement slurry through suction. Again, in such embodiments, the fiber cement slurry can in principle be squeezed together against the water-permeable belt in any possible direction (i.e. up, down, left, right etc.).

In particular embodiments, however, the fiber cement slurry is squeezed together against the surface of the water-permeable belt in the vertically downward direction, i.e. in substantially the same direction as that of the force of gravity.

In further particular embodiments, both mechanical and physical forces can be used to remove the excess of water from the fiber cement structure thereby increasing the density thereof. For instance, in certain particular embodiments, both mechanical pressing and suction can be used to remove the excess of water from the fiber cement structure. For example, one or more mechanical presses and one or more vacuum pumps can be used consecutively, simultaneously or in combination to remove the excess of water from the fiber cement slurry. In such embodiments, the fiber cement slurry can in principle be pressed and squeezed together against the water-permeable belt in any possible direction (i.e. up, down, left, right etc.) although the vertically downward direction, i.e. the same direction as that of the force of gravity, is particularly preferred.

In certain particular embodiments of the processes of the invention, the step of removing excess of water from the fiber cement slurry by means of suction through the water-permeable transport belt takes place in at least two, such as at least three, consecutive zones of the belt, which zones are characterized by undergoing different under-pressures.

In particular embodiments, the dewatering of the fiber cement slurry takes place in at least two zones with different underpressures. The more subdivisions or zones are created, the more the suction distribution can be optimized for various criteria (minimum energy use of the pumps, shortest possible dewatering zones, smallest possible screen tension).

The absolute length of each of the zones with different underpressure is not critical. At a given length of the dewatering zone, the skilled person will understand that the speed of the belt and/or the underpressure can be suitably adjusted to ensure a sufficient degree of dewatering.

In particular embodiments, the absolute length of each of the zones with different underpressure is at least identical to the absolute length of the fiber cement sheet to be produced.

The lengths of the different zones submitted to different underpressures relative to one another is not critical as long as the fiber cement slurry has a composition that is sufficiently permeable. Thus in particular embodiments, the individual zones with different underpressures are each approximately of the same length.

In other particular embodiments, in the case of a fiber cement slurry that is not sufficiently permeable and when two dewatering zones are present, the first zone (with the lowest underpressure) should be at least twice as long as the second zone (with the highest underpressure).

In yet other particular embodiments, in the case of a fiber cement slurry that is not sufficiently permeable and when three dewatering zones are present, the first zone (with the lowest underpressure) should at least be as long as the two remaining zones (with intermediate and highest underpressure, respectively) together.

In particular embodiments, the step of removing excess of water from the fiber cement slurry by means of suction through the water-permeable transport belt takes place in at least two consecutive zones of the belt, wherein the under-pressure of a first zone ranges between about 15 mbar and about 65 mbar and in a second zone ranges between about 65 mbar and about 200 mbar.

In further particular embodiments, the step of removing excess of water from the fiber cement slurry by means of suction through the water-permeable transport belt takes place in at least three consecutive zones of the belt, wherein the under-pressure of a first zone ranges between about 15 mbar and about 65 mbar, in a second zone ranges between about 65 mbar and about 200 mbar, and in a third zone between about 200 mbar to about 550 mbar.

In yet further particular embodiments, the step of removing excess of water from the fiber cement slurry by means of suction through the water-permeable transport belt takes place in at least four consecutive zones of the belt, wherein the under-pressure of a first zone ranges between about 15 mbar and about 65 mbar, in a second zone ranges between about 65 mbar and about 200 mbar, in a third zone between about 200 mbar and about 600 mbar, and in a fourth zone between about 660 mbar and about 850 mbar.

In still further particular embodiments, the step of removing excess of water from the fiber cement slurry by means of suction through the water-permeable transport belt takes place in at least four, such as at least five, such as up to at least six consecutive zones of the belt with different increasing under-pressures.

In yet further particular embodiments of the processes of the invention, the freshly deposited fiber cement slurry layer is first subjected to a first zone on the water-permeable conveyor belt, which is characterized by an under-pressure between about 15 and about 65 mbar, and subsequently subjected to a second zone on the water-permeable conveyor belt, which is characterized by an under-pressure between about 65 and about 200 mbar, and finally subjected to a third zone on the water-permeable conveyor belt which is characterized by an under-pressure between about 200 and about 550 mbar, in that particular order.

The present inventors have found that by subjecting the product in preparation to this specific combination of consecutive zones having increasing under-pressures, an optimal dewatering of the fiber cement sheet can be achieved. In fact, if the fiber cement slurry layer is subjected to only one single under-pressure zone, the under-pressure is either too low to have an optimal dewatering effect or too high, which typically causes undesirable cracks, bubbles and wrinkles in the fiber cement sheet. The inventors have now found that by creating a gradient of increasing under-pressures, the product is slowly and carefully subjected to increasing under-pressures, thereby avoiding damage to the final product while still allowing sufficient dewatering.

It will be understood that the processes of the invention will also have the same beneficial effects when more than three consecutive under-pressure zones are applied, as long as the under-pressures increase in the machine direction (i.e. production direction), thereby ensuring that the product is gradually subjected from a low under-pressure (i.e. at least 20 mbar) to a high under-pressure (i.e. at most 900 mbar).

In further particular embodiments, the step of removing excess of water from the slurry through the water-permeable transport belt is done by suction as described above, followed by applying mechanical force. In yet further particular embodiments, the step of removing excess of water from said slurry through said water-permeable transport belt is is done by suction as described above, followed by applying mechanical force by means of one or more mechanical belt presses and/or pressure plates. The pressure of the mechanical belt press may lie between about 10 kg/cm and about 50 kg/cm.

In further particular embodiments, the processes of the present invention can comprise the additional but optional step of leveling out or smoothening the surface of the produced fiber cement layer. This step can for example be performed by means of a mechanical belt press. Alternatively or additionally, smoothening out the surface of the produced fiber cement sheets can for instance be performed by means of one or more oscillating rods moving transversely to the travel direction of the transport belt. In these embodiments, the oscillation may have for instance an amplitude in the range between about 1 cm and about 5 cm, a frequency between about 5 Hz to about 20 Hz and a line contact pressure between about 3 N/cm to about 20 N/cm. With such assistance, the surface of the sheet can be further leveled out.

The processes according to the present invention may further comprise the step of cutting the fiber cement layer obtained in step (c) to a predetermined length to form a fiber cement sheet. Cutting the fiber cement sheet to a predetermined length can be done by any technique known in the art, such as but not limited to water jet cutting, air jet cutting or the like. The fiber cement sheets can be cut to any desirable length, such as but not limited to a length of between about 1 m and about 15 m, such as between about 1 m and about 10 m, more particularly between about 1 m and about 5 m, most particularly between about 1 m and about 3 m.

It will be understood by the skilled person that the processes of the present invention may further comprise additional steps of processing the produced fiber cement sheets.

For instance, in certain particular embodiments, during the processes of the present invention, the fiber cement slurry and/or the fiber cement sheets can undergo various intermediate treatments, such as but not limited to treatment with one or more hydrophobic agents, treatment with one or more flocculants, additional or intermediate pressing steps, etc.

It will be clear to the person skilled in the art that such intermediate processing steps can be introduced in the processes of the invention at any stage, i.e. before, during and/or after the step of discharging the fiber cement slurry onto the transport belt and/or before, during and/or after the step of removing excess of water from the fiber cement slurry.

As soon as the fiber cement sheet is formed, it is trimmed at the lateral edges. The border strips can optionally be recycled through immediate mixing with the recycled water and directing the mixture to the mixing system again.

In particular embodiments of the present invention, after the step of removing excess of water from the fiber cement slurry, the processes of the present invention may further comprise the step of producing a corrugated fiber cement sheet from the obtained fiber cement sheet. In these embodiments, the step of producing the corrugated fiber cement sheet may comprise for example at least the step of transferring the obtained fiber cement sheet to a corrugated sheet mold to form a corrugated fiber cement sheet. However, other techniques to produce corrugated sheets from flat sheets are known to the skilled person and may as well be used in combination with the processes of the present invention in order to obtain corrugated fiber cement sheets.

In particular embodiments, the processes of the invention may further comprise the step of curing the obtained fiber cement sheets. Indeed, after production, fiber cement products can be allowed to cure over a time in the environment in which they are formed, or alternatively can be subjected to a thermal cure (e.g. by autoclaving or the like).

In further particular embodiments, the “green” fiber cement sheet is cured, typically by curing to the air (air cured fiber cement products) or under pressure in presence of steam and increased temperature (autoclave cured). For autoclave cured products, typically sand is added to the original fiber cement slurry. The autoclave curing in principle results in the presence of 11.3 Å (angstrom) Tobermorite in the fiber cement product.

In yet further particular embodiments, the “green” fiber cement sheet may be first pre-cured to the air, after which the pre-cured product is further air-cured until it has its final strength, or autoclave-cured using pressure and steam, to give the product its final properties.

In particular embodiments of the present invention, the processes may further comprise the step of thermally drying the obtained fiber cement sheets. After curing, the fiber cement product being a panel, sheet or plate, may still comprise a significant weight of water, present as humidity. This may be up to 10 even 15% w, expressed per weight of the dry product. The weight of dry product is defined as the weight of the product when the product is subjected to drying at 105° C. in a ventilated furnace, until a constant weight is obtained.

In certain embodiments, the fiber cement product is dried. Such drying is done preferably by air drying and is terminated when the weight percentage of humidity of the fiber cement product is less than or equal to 8 weight %, even less than or equal to 6 weight %, expressed per weight of dry product, and most preferably between 4 weight % and 6 weight %, inclusive.

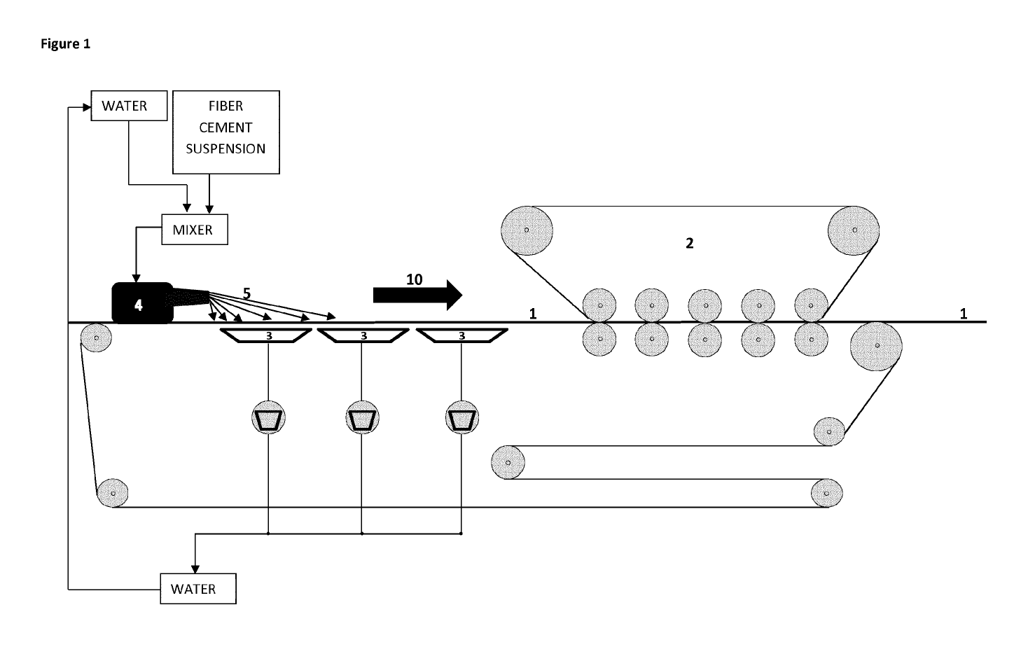

Referring to FIG. 1, one specific embodiment of the presently disclosed process is schematically illustrated. According to the illustrated embodiment, a cementitious slurry composition essentially consisting of fibers, cement and water, is continuously discharged on a water-permeable belt (1) by means of a flow-on distribution device (4), i.e. producing a continuous flow (5) of the fiber cement composition.

After the flow-on distribution device (4) has provided a layer of slurry directly on top of the belt (1), excess of water is removed from the formed fiber cement layer by means of three consecutively installed vacuum boxes (pumps (3)), each having different underpressures increasing in the machine direction (arrow (10)).

Subsequently, additional excess of water is then removed from the formed fiber cement layer by the mechanical belt press (2) to form a fiber cement sheet with a predetermined and accurate thickness and density.

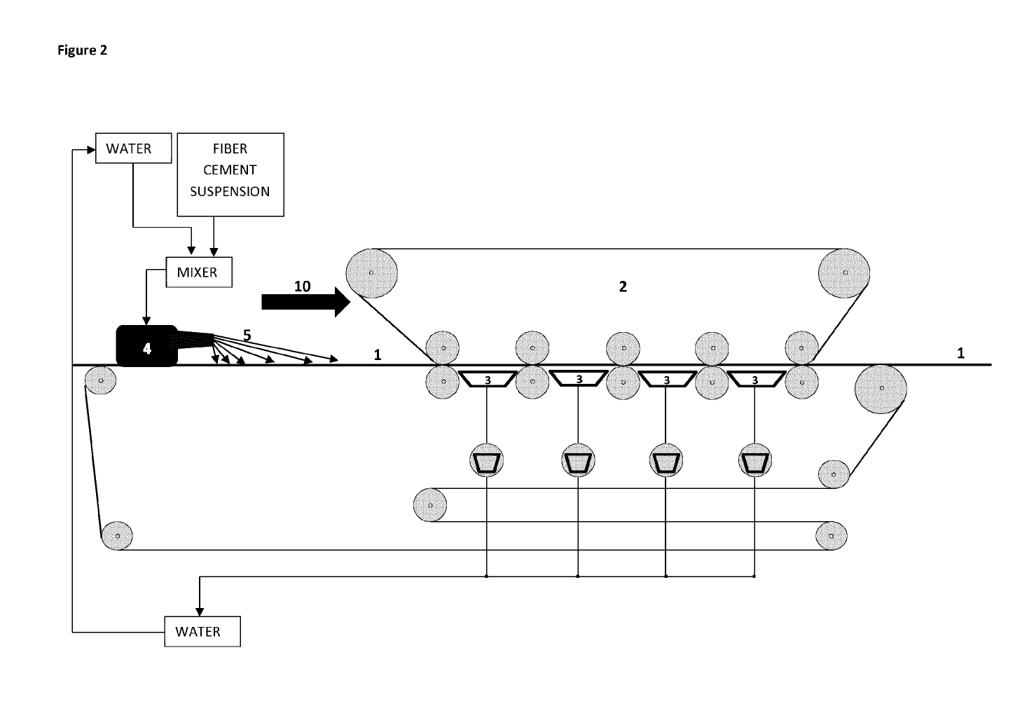

FIG. 2 illustrates another specific embodiment of the present invention. According to this embodiment, a cementitious slurry composition essentially consisting of fibers, cement and water, is continuously discharged on a water-permeable belt (1) by means of a flow-on distribution device (4), i.e. producing a continuous flow (5) of the fiber cement composition.

After the flow-on distribution device (4) has provided a layer of slurry directly on top of the belt (1), excess of water is removed from the formed fiber cement layer by means of a combination of the mechanical belt press (2), installed above the water-permeable belt, and three consecutively installed vacuum boxes (pumps (3)), installed underneath the belt. The vacuum pumps preferably have different underpressures increasing in the machine direction (arrow (10)).

In this way, a fiber cement sheet with a predetermined and accurate thickness and density is formed.

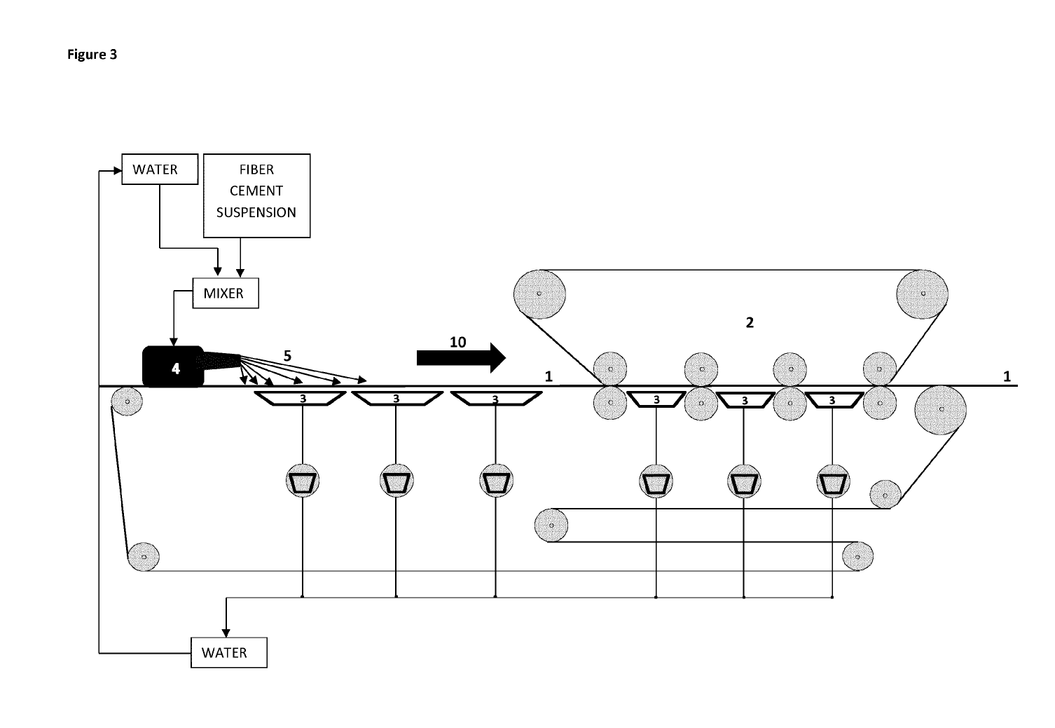

FIG. 3 illustrates yet another specific embodiment of the present invention. According to this embodiment, a cementitious slurry composition essentially consisting of fibers, cement and water, is continuously discharged on a water-permeable belt (1) by means of a flow-on distribution device (4), i.e. producing a continuous flow (5) of the fiber cement composition.

After the flow-on distribution device (4) has provided a layer of slurry directly on top of the belt (1), excess of water is removed from the formed fiber cement layer by means of three consecutively installed vacuum boxes (pumps (3)), each having different underpressures increasing in the machine direction (arrow (10)).

Subsequently, additional excess of water is then removed from the formed fiber cement layer through a combination of a mechanical belt press (2), installed above the water-permeable belt, and three consecutively installed vacuum boxes (pumps (3)), installed underneath the belt.

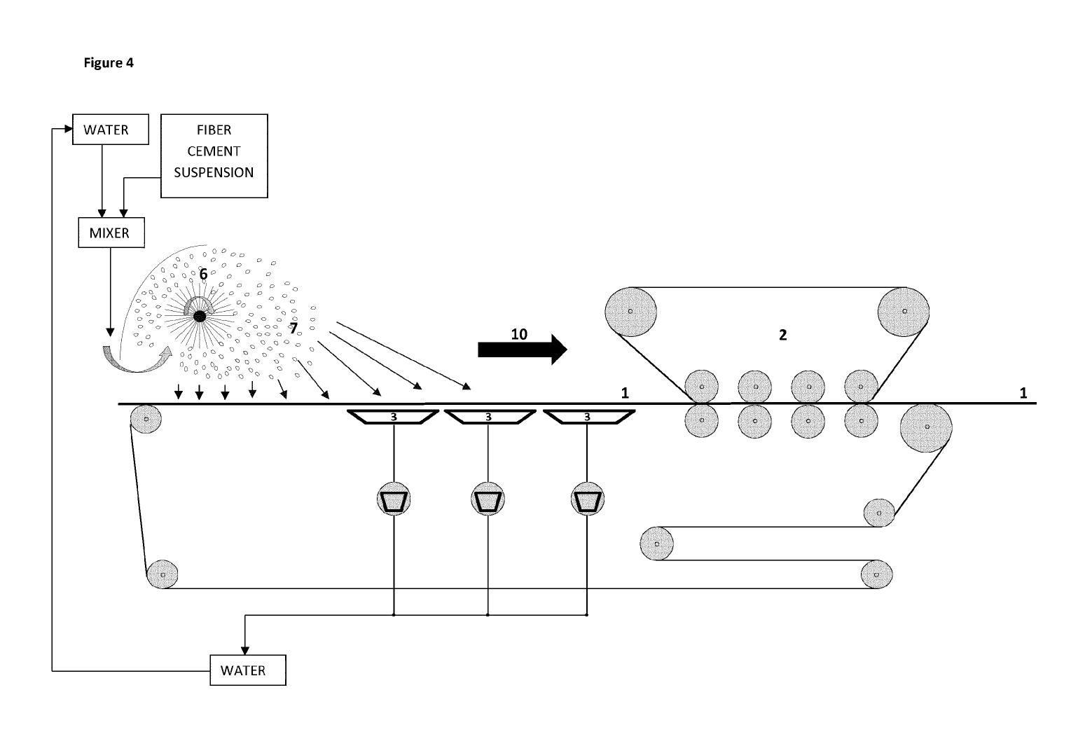

In this way, a fiber cement sheet with a predetermined and accurate thickness and density is formed. Referring to FIG. 4, illustrating yet a further specific embodiment of the presently disclosed process, a cementitious slurry composition essentially consisting of fibers, cement and water, is continuously discharged on a water-permeable belt (1) by means of a spattering (i.e. brush-like) distribution device (6), i.e. producing a continuous spatter of droplets (7) of the fiber cement composition.

After the spattering distribution device (6) has provided a layer of slurry directly on top of the belt (1), excess of water is removed from the formed fiber cement layer by means of three consecutively installed vacuum boxes (pumps (3)), each having different underpressures increasing in the machine direction (arrow (10)).

Subsequently, additional excess of water is then removed from the formed fiber cement layer by the mechanical belt press (2) to form a fiber cement sheet with a predetermined and accurate thickness and density.

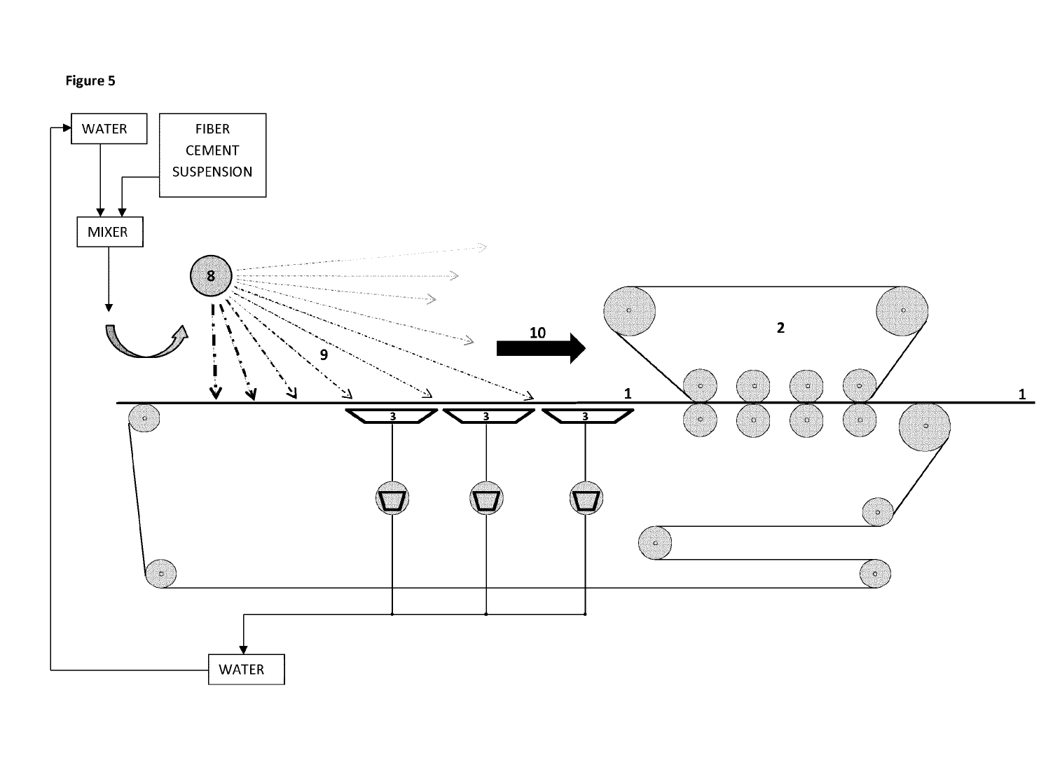

In FIG. 5, one other specific embodiment of the presently disclosed process is illustrated. A cementitious slurry composition essentially consisting of fibers, cement and water, is continuously discharged on a water-permeable belt (1) by means of a spraying distribution device (8), i.e. producing a continuous spray (9) of the fiber cement composition.

After the spraying distribution device (8) has provided a layer of slurry directly on top of the belt (1), excess of water is removed from the formed fiber cement layer by means of three consecutively installed vacuum boxes (pumps (3)), each having different underpressures increasing in the machine direction (arrow (10)).

Subsequently, additional excess of water is then removed from the formed fiber cement layer by the mechanical belt press (2) to form a fiber cement sheet with a predetermined and accurate thickness and density.

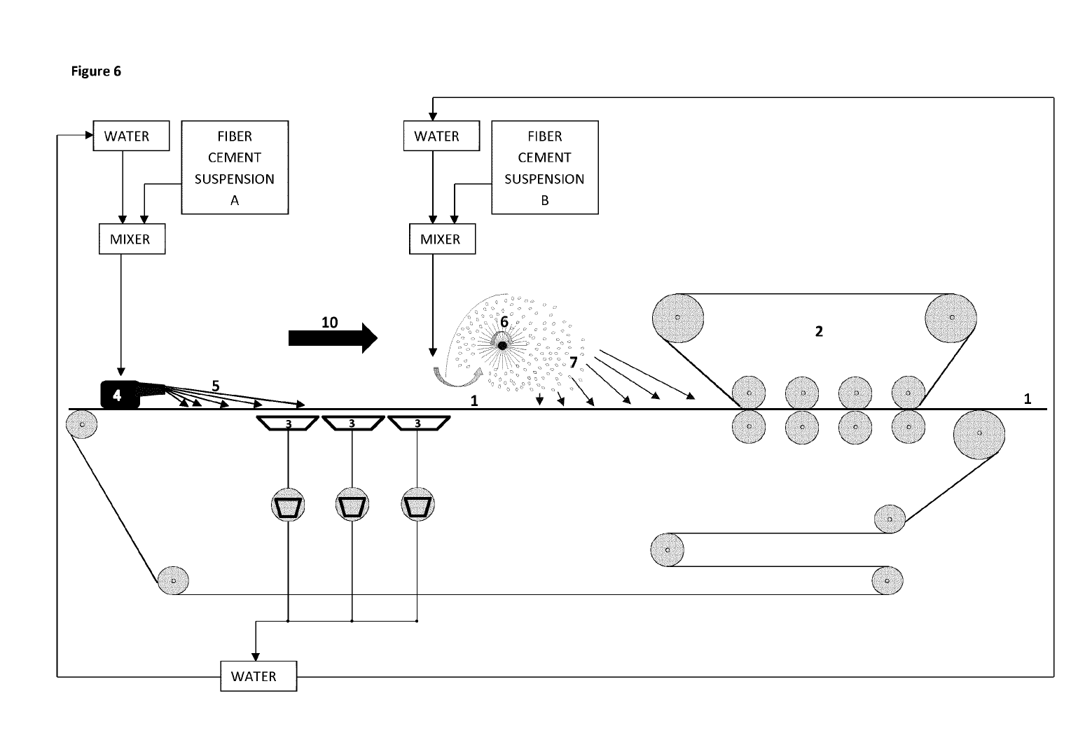

Referring to FIG. 6, one further specific embodiment of the presently disclosed process is schematically illustrated. According to the illustrated embodiment, two different cementitious slurry compositions (A) and (B) essentially consisting of fibers, cement and water are supplied, wherein the fiber content of fiber cement composition (A) is different from the fiber content of fiber cement composition (B).

Fiber cement composition (A) is continuously discharged on the belt (1) by means of a flow-on distribution device (4), i.e. producing a continuous flow (5) of fiber cement composition (A).

After the flow-on distribution device (4) has provided a layer of slurry (A) directly on top of the belt (1) excess of water is removed from the formed fiber cement layer by means of three consecutively installed vacuum boxes (pumps (3)), each having different underpressures, increasing in the machine direction (arrow (10)).

Subsequently, fiber cement composition (B) is continuously discharged on the belt (1) by means of a brush-like distribution device (6), which continuously and randomly spatters droplets (7) of fiber cement slurry (B) in the direction of the surface of the water-permeable transport belt (1) on top of the previously dispensed layer of slurry (A).

Excess of water is then removed from the formed fiber cement multi-layer by mechanically pressing the multi-layered sheet to form a multi-layered fiber cement sheet with a predetermined accurate thickness and density.

Thus, the one or more dispensing systems as installed in the present embodiment are used to create a multi-layered fiber cement sheet consisting of a first layer having composition (A) and a second layer having composition (B), generating a so-called two-layered fiber cement sheet.

It is clear that it is also envisaged in the present invention, in an analogous way as presented in FIG. 6, to provide three or more different cementitious slurry compositions, such as for instance three fiber cement compositions (A), (B) and (C) essentially consisting of fibers, cement and water, wherein the fiber content of fiber cement compositions (A), (B) and (C) are different from each other.

First, fiber cement composition (A) can be continuously discharged on the belt (1) by means of a brush-like distribution device (6), which continuously and randomly spatters droplets (7) of fiber cement slurry (A) in the direction of the surface of the water-permeable transport belt (1).

After the spattering distribution device (6) has provided a layer of slurry (A) directly on top of the belt (1) excess of water can be removed from the formed fiber cement layer by means of a mechanical belt press.

Subsequently, fiber cement composition (B) can be continuously discharged on the belt (1) by means of a flow-on distribution device (4), i.e. producing a continuous flow (5) of fiber cement composition (B) on top of the previously dispensed layer of slurry (A).

Excess of water can then be removed from the formed fiber cement multi-layer by means of three consecutively installed vacuum boxes (pumps (3)), each having different underpressures, increasing in the machine direction (arrow (10)).

After the flow-on distribution device (4) has provided a layer of slurry (B) on top of previously spattered layer A, fiber cement composition (C) can be continuously discharged on the belt (1) by means of another flow-on device, or another brush-like distribution device, or a spraying distribution device, which continuously and randomly produces a flow, spatters, or sprays, respectively fiber cement slurry (C) on the previously formed two-layer (A-B).

Excess of water can be removed from the formed fiber cement two-layer (A-B) by means of mechanically pressing the multi-layered sheet to form a multi-layered fiber cement sheet with a predetermined and accurate thickness and density.

Thus, the one or more distribution systems in the above described embodiments are used to create a multi-layered fiber cement sheet consisting of two, three or more layers, depending on the design or format of the desired sheet, generating a two-layered or multi-layered fiber cement sheet.

Additionally, a spraying system can be installed at the end of the production line in order to provide the formed multi-layered fiber cement sheet with a coating of hydrophobic agent.

In a second aspect, the present invention provides fiber cement sheets obtainable by the processes according to the invention as described in detail herein.

In the context of the present invention, fiber cement products or sheets are to be understood as cementitious products comprising cement and synthetic (and optionally natural) fibers. The fiber cement products are made out of fiber cement slurry, which is formed in a so-called “green” fiber cement product, and then cured.

Dependent to some extent on the curing process used, the fiber cement slurry typically comprises water, process or reinforcing fibers which are synthetic organic fibers (and optionally also natural organic fibers, such as cellulose), cement (e.g. Portland cement), limestone, chalk, quick lime, slaked or hydrated lime, ground sand, silica sand flour, quartz flour, amorphous silica, condensed silica fume, microsilica, kaolin, metakaolin, wollastonite, mica, perlite, vermiculite, aluminum hydroxide (ATH), pigments, anti-foaming agents, flocculants, and/or other additives. Optionally color additives (e.g. pigments) are added, to obtain a fiber cement product which is so-called colored in the mass.

In particular embodiments, the fiber cement sheets obtainable by the processes of the invention have a predetermined thickness of at least about 3 mm, because otherwise the losses of solid matter with the aspired water increase strongly. In more particular embodiments, the fiber cement sheets obtainable by the processes of the invention have a predetermined thickness of between about 8 mm and about 200 mm, such as between about 10 mm and about 200 mm.

The thickness of the dewatered layer (which should match the predetermined thickness) is the control value for the amount of material supplied per time unit. In particular embodiments, the thickness of the dewatered layer can be measured. This can for instance be done through a contact lens profile measurement. Its evaluation also permits an adjustment of the device for the distribution of the suspension across the transport belt width.

The fiber cement products or sheets as referred to herein include roof or wall covering products made out of fiber cement, such as fiber cement sidings, fiber cement boards, flat fiber cement sheets, corrugated fiber cement sheets and the like. According to particular embodiments, the fiber cement products according to the invention can be roofing or façade elements, flat sheets or corrugated sheets.

According to further particular embodiments, the fiber cement products of the present invention are fiber cement sheets, in particular corrugated fiber cement sheets.

The fiber cement products of the present invention comprise from about 0.1 to about 5 weight %, such as particularly from about 0.5 to about 4 weight % of fibers, such as more particularly between about 1 to 3 weight % of fibers with respect to the total weight of the fiber cement product.

According to particular embodiments, the fiber cement products according to the invention are characterized in that it comprises fibers chosen from the group consisting of cellulose fibers or other inorganic or organic reinforcing fibers in a weight % of about 0.1 to about 5. In particular embodiments, organic fibers are selected from the group consisting of polypropylene, polyvinylalcohol polyacrylonitrile fibers, polyethyelene, cellulose fibres (such as wood or annual kraft pulps), polyamide fibers, polyester fibers, aramide fibers and carbon fibers. In further particular embodiments, inorganic fibers are selected from the group consisting of glass fibers, rockwool fibers, slag wool fibers, wollastonite fibers, ceramic fibers and the like. In further particular embodiments, the fiber cement products of the present invention may comprise fibrils fibrids, such as for example but not limited to, polyolefinic fibrils fibrids % in a weight % of about 0.1 to 3, such as “synthetic wood pulp”.

According to certain particular embodiments, the fiber cement products of the present invention comprise 20 to 95 weight % cement as hydraulic binder. Cement in the products of the invention is selected from the group consisting of Portland cement, cement with high alumina content, Portland cement of iron, trass-cement, slag cement, plaster, calcium silicates formed by autoclave treatment and combinations of particular binders. In more particular embodiments, cement in the products of the invention is Portland cement.

According to particular embodiments, the fiber cement products according to the invention optionally comprise further components. These further components in the fiber cement products of the present invention may be selected from the group consisting of water, sand, silica sand flour, condensed silica fume, microsilica, fly-ashes, amorphous silica, ground quartz, the ground rock, clays, pigments, kaolin, metakaolin, blast furnace slag, carbonates, puzzolanas, aluminium hydroxide, wollastonite, mica, perlite, calcium carbonate, and other additives (e.g. colouring additives) etc. It will be understood that each of these components is present in suitable amounts, which depend on the type of the specific fiber cement product and can be determined by the person skilled in the art. In particular embodiments, the total quantity of such further components is preferably lower than 70 weight % compared to the total initial dry weight of the composition.

Further additives that may be present in the fiber cement products of the present invention may be selected from the group consisting of dispersants, plasticizers, antifoam agents and flocculants. The total quantity of additives is preferably between about 0.1 and about 1 weight % compared to the total initial dry weight of the composition.

According to a third aspect, the present invention provides apparatuses for continuous production of fiber cement sheets, which apparatuses at least comprise:

(i) one or more distribution devices connected to a fiber cement source for continuously discharging a fiber cement slurry on an endless water-permeable transport belt, and
(ii) an endless water-permeable transport belt onto which the slurry is discharged.

In particular embodiments, the apparatuses of the present invention further may comprise at least one dewatering device which is installed adjacent or near to the water-permeable belt so as to achieve, facilitate and/or accelerate the removal of excess of water from the fiber cement slurry thereby forming a fiber cement sheet with a predetermined thickness. In further particular embodiments, the at least one dewatering device which is installed adjacent to the water-permeable belt so as to achieve, facilitate and/or accelerate the removal of excess of water from the fiber cement slurry is at least one mechanical dewatering device, such as but not limited to one or more mechanical belt presses, and/or one or more suction dewatering devices, such as but not limited to one or more vacuum pumps.

Thus, according to certain particular embodiments, the apparatuses for continuous production of fiber cement sheets according to the present invention at least comprise:

(i) one or more fiber cement slurry distribution devices connected to a fiber cement source for continuously discharging a fiber cement slurry on an endless water-permeable transport belt,
(ii) an endless water-permeable transport belt onto which the slurry is discharged, and
(iii) one or more dewatering devices installed adjacent to or near the water-permeable belt so as to achieve, facilitate and/or accelerate the removal of excess of water from the fiber cement slurry thereby forming a fiber cement sheet with a predetermined thickness.

According to further particular embodiments, the apparatuses for continuous production of fiber cement sheets according to the present invention at least comprise:
(i) one or more units known per se for the production and/or supply of a fiber cement slurry;
(ii) one or more distribution devices connected to a fiber cement source for continuously discharging a fiber cement slurry on an endless water-permeable transport belt,
(iii) an endless water-permeable transport belt onto which the slurry is discharged, and
(iv) one or more dewatering devices installed adjacent to or near the water-permeable belt so as to achieve, facilitate and/or accelerate the removal of excess of water from the fiber cement slurry thereby forming a fiber cement sheet with a predetermined thickness.

According to one particular embodiment, as set out in FIGS. 1 to 6, an apparatus according to the invention for carrying out the processes described herein, comprises:
a unit known per se for the production and/or supply of a fiber cement slurry;
a continuous mixing device for fiber cement slurry known per se;
a fiber cement slurry distribution device (4), (6) and/or (8) for discharging the fiber cement slurry;
a water permeable transport belt (1)
a mechanical dewatering device (2);
at least two, such as at least three, dewatering suction devices (3) arranged underneath the water-permeable belt, which are operated with different underpressures;
optionally, a device for assisting densification, smoothening and/or levelling out the surface of the formed fiber cement sheet;
one or more units known per se for trimming, cutting, setting, drying, optionally impregnating, stacking and packaging of the sheets.

The fiber cement slurry is produced or supplied in a unit as shown in FIGS. 1 to 6. From the mixing device (as shown in FIGS. 1 to 6) the fiber cement slurry is loaded on the water-permeable screen belt (1) via a distribution device (4), (6) and/or (8). It is dewatered on the dewatering suction devices (3) in three zones with different increasing pressures. Simultaneously or additionally, a mechanical belt press (2) operates so that water continues to be expelled, but it can also only smoothen the surface. Optionally, the press and/or the suction devices can be eliminated, so that dewatering solely occurs through the force of gravity.

According to a fourth aspect, the present invention provides uses of the fiber cement products and fiber cement sheets obtainable by the processes and apparatuses according to the present invention in the building industry. In particular embodiments, the fiber cement sheets produced by the processes of the present invention can be used to provide an outer surface to walls, both internal as well as external a building or construction, e.g. as façade plate, siding, etc.

The invention will now be further illustrated in detail with reference to the following Examples. It is to be understood that although preferred embodiments and/or materials have been discussed for providing embodiments according to the present invention, various modifications or changes may be made without departing from the scope and spirit of this invention.

### EXAMPLES

It will be appreciated that the following examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention that is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

### Example 1: Production of Fiber Cement Sheets According to the Processes of the Invention

One-layered fiber cement sheets were produced using the processes according to the present invention. A fiber cement slurry composition was prepared, mainly consisting of Portland cement, water, and about 5% of cellulose fibers (percentage of the total weight of slurry) by continuously mixing at least fibers, cement and water in a container.

The predetermined density was set to be between about 0.55.

The prepared fiber cementitious slurry was continuously discharged on an endless water-permeable transport belt using a flow-on distribution system producing a continuous flow of the fiber cement slurry onto a water-permeable felt transport belt.

Excess of water was removed from the slurry through the water-permeable transport belt using suction thereby increasing the density of the fiber cement layer. More particularly, three consecutive vacuum pumps with increasing underpressures of between about 15 and about 65 mbar, between about 65 and about 200 mbar and between about 200 to about 550 mbar, respectively, installed underneath the water-permeable belt, were used to remove the excess of water from the fiber cement layer through suction.

Additionally, a mechanical press was used to squeeze remaining water out of the pores and passages in the fiber cement structure and thereby increasing the density thereof.

The obtained fiber cement layer was cut to a predetermined length of about 1.30 m to form a fiber cement sheet using a water jet cutter.

The formed fiber cement sheet was trimmed at the lateral edges and autoclave cured. The formed fiber cement sheets were analyzed for their different mechanical and physical characteristics (see Table 1).

TABLE 1

| | | | | | Thermal |
|---|---|---|---|---|---|
| Fiber | | | | | shrinkage |
| cement | | | | | after 4 h at |
| sheet | Thickness | Strength | E-Modulus | Density | 1000° C. |
| reference | (mm) | (N/mm²) | (N/mm²) | (kg/dm³) | (%) |
| 1 | 25.5 | 3.0 | 1115 | 0.58 | 1.76 |
| 2 | 24.5 | 2.0 | 911 | 0.51 | 1.79 |
| 3 | 23.6 | 3.3 | 1550 | 0.52 | — |
| 4 | 21.0 | 4.6 | 2097 | 0.62 | 3.24 |
| 5 | 20.5 | 3.8 | 1770 | 0.56 | 4.03 |
| 6 | 23.2 | 3.7 | 1022 | 0.52 | 3.95 |
| 7 | 25.0 | 3.5 | 1216 | 0.51 | 3.86 |
| 8 | 25.0 | 4.1 | 1230 | 0.50 | 3.18 |

### CONCLUSION

The results clearly show that the processes according to the present invention allow to produce fiber cement sheets having a predetermined and accurate density and thickness, which was not possible with known “non-Hatschek” processes up to now.

Indeed, the obtained density of the sheets using a same process (i.e. with a predetermined density of about 0.55) resulted in an average density of about 0.56 kg/dm³, demonstrating the ability to accurately predetermine the density of the sheets to be produced with the processes of the invention.

Furthermore, it is shown in Table 1 that the thicknesses of the sheets have remained relatively constant in this tuning process.

Finally, strength, modulus and thermal shrinkage remained well within the generally accepted ranges as known to the person skilled in the art.

Accordingly, the present inventors have developed a process allowing for the production of monolithic fiber cement sheets having sufficient strength in all directions and having the desired predetermined density, length and thickness.

1. A process for the production of a fiber cement sheet, comprising the steps of:
(a) providing a fiber cementitious slurry comprising fibers, cement and water,
(b) continuously discharging said fiber cementitious slurry on an endless water-permeable transport belt, and
(c) removing excess of water from said fiber cementitious slurry through said water-permeable transport belt by suction, to form a fiber cement sheet with a predetermined thickness.

2. The process according to claim 1, wherein removing excess of water from said slurry by suction through said water-permeable transport belt takes place in at least three consecutive zones with different under-pressures.

3. The process according to claim 2, wherein the under-pressure of a first of said zones ranges between about 15 and about 65 mbar, in a second of said zones between about 65 and about 200 mbar and in a third of said zones between about 200 to about 550 mbar.

4. The process according to claim 1, wherein removing excess of water from said slurry by suction through said water-permeable transport belt takes place in at least four consecutive zones, the under-pressure of a first of said zones ranges between about 15 and about 65 mbar, in a second of said zones between about 65 and about 200 mbar, in a third of said zones between about 200 to about 550 mbar, and in a fourth of said zones between about 550 mbar and about 850 mbar.

5. The process according to claim 1, wherein step (c) of removing excess of water from said fiber cementitious slurry through said water-permeable transport belt is additionally performed by applying mechanical force.

6. The process according to claim 5, wherein the step of removing excess of water from said fiber cementitious slurry by applying mechanical force is performed by a mechanical belt press.

7. The process according to claim 1, wherein step (b) of continuously discharging the slurry on an endless water-permeable transport belt is performed by one or more flow-on systems through which said slurry is continuously dispensed on the belt.

8. The process according to claim 1, wherein step (b) of continuously discharging the slurry on an endless water-permeable transport belt is performed by one or more brush-like dispensing systems, through which said slurry is continuously and randomly sputtered on the belt.

9. The process according to claim 1, wherein step (b) of continuously discharging the slurry on an endless water-permeable transport belt is performed by one or more spraying systems, through which said slurry is continuously and randomly sprayed on the belt.

10. The process according to claim 1, further comprising the step of spraying a hydrophobic substance onto the discharged fiber cement slurry and/or onto the obtained fiber cement sheet.

11. The process according to claim 1, wherein the predetermined thickness of the dewatered fiber cement sheet ranges between about 8 mm and about 200 mm.

12. Fiber cement sheet obtainable by the process according to claim 1.

13. Apparatus for continuous production of fiber cement sheets, at least comprising:
(i) one or more dispensing systems connected to a fiber cement source for continuously discharging a fiber cement slurry on an endless water-permeable transport belt,
(ii) an endless water-permeable transport belt onto which the fiber cement slurry is discharged, and
(iii) one or more devices installed adjacent to or near the water-permeable belt to achieve, facilitate and/or accelerate the removal of excess of water from the fiber cement slurry, thereby forming a fiber cement sheet with a predetermined thickness.

14. The apparatus according to claim 13, wherein said one or more devices installed adjacent to or near the water-permeable belt are one or more mechanical belt presses and/or one or more vacuum pumps.

15. The apparatus according to claim 13, wherein said one or more dispensing systems are one or more flow-on systems through which said slurry is continuously dispensed on the belt and/or one or more brush-like dispensing systems, through which said slurry is continuously and randomly sputtered on the belt and/or one or more spraying systems, through which said slurry is continuously and randomly sprayed on the belt.

16. The apparatus according to claim 14, wherein said one or more dispensing systems are one or more flow-on systems through which said slurry is continuously dispensed on the belt and/or one or more brush-like dispensing systems, through which said slurry is continuously and randomly sputtered on the belt and/or one or more spraying systems, through which said slurry is continuously and randomly sprayed on the belt.

17. The process according to claim 3, wherein removing excess of water from said slurry by suction through said water-permeable transport belt takes place in at least four consecutive zones, the under-pressure of a first of said zones ranges between about 15 and about 65 mbar, in a second of said zones between about 65 and about 200 mbar, in a third of said zones between about 200 to about 550 mbar, and in a fourth of said zones between about 550 mbar and about 850 mbar.

18. The process according to claim 2, wherein removing excess of water from said slurry by suction through said water-permeable transport belt takes place in at least four consecutive zones, the under-pressure of a first of said zones ranges between about 15 and about 65 mbar, in a second of said zones between about 65 and about 200 mbar, in a third of said zones between about 200 to about 550 mbar, and in a fourth of said zones between about 550 mbar and about 850 mbar.

19. The process according to claim 18, wherein step (c) of removing excess of water from said fiber cementitious slurry through said water-permeable transport belt is additionally performed by applying mechanical force.

20. The process according to claim 17, wherein step (c) of removing excess of water from said fiber cementitious slurry through said water-permeable transport belt is additionally performed by applying mechanical force.
